(19) United States
(12) Patent Application Publication
(10) Pub. No.: US 2006/0101076 A1
(43) Pub. Date: May 11, 2006

(54) Electronic file system graphic user interface including user defined relationship symbology between folders

(76) Inventors: Parag Patel, Marina Del Rey, CA (US); Alok K. Gupta, Venice, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/985,363

(22) Filed: Nov. 10, 2004

(51) Int. Cl. G06F 17/00

(52) U.S. Cl. 707/104.1

(57) ABSTRACT

An electronic file system graphic user interface for representation of electronic files. The graphic user interface includes a graphically indicated first main folder, a graphically indicated second main folder, and user defined relationship symbology displayable between the first and second main folders. The electronic files are represented as storable in the first and second main folders.

### BACKGROUND OF THE INVENTION

1. Field of the Invention

The present invention relates generally to electronic files systems, and in particular to an electronic file system graphic user interface including user defined relationship symbology between folders.

2. Description of the Prior Art

There are a variety of graphic user interfaces formats for electronic file systems. A common graphic user interface involves a user to being able to interact with electronic files that are organized and stored in folders and subfolders. Folders and electronic files may be initially stored in a main index or directory. These may be listed in alphabetical order, by file/folder size, file type, or date the file was last saved for example. In addition, within a given folder there may be contained subfolders and electronic files that may also be listed in alphabetical order of file/folder name, by file/folder size, file type, date the files were last saved, or by alphabetical order by author, for example. Typically the user does not have control in the ordering of such files/folders except by specifying how all of the files in a given folder are to be presented (e.g., by alphabetical order, in alphabetical order of file/folder name, by file/folder size, etc.). In a WINDOWS format, electronic files and folders may be graphically presented in a display window with the user able to position such files and folders.

Whether indexed or presented graphically in a window, the relationship between various folders is not readily apparent. As such the task of determining a specific folder to store a given electronic file/folder/subfolder or where to seek the location of a given file/folder/subfolder may become complex and unnecessarily time-consuming. Accordingly, there is a need in the art for an improved graphic user interface for an electronic file system.

### SUMMARY OF THE INVENTION

An aspect of the present invention can be regarded as an electronic file system graphic user interface for representation of electronic files. The graphic user interface includes a graphically indicated first main folder, a graphically indicated second main folder, and user defined relationship symbology displayable between the first and second main folders. The electronic files are represented as storable in the first and second main folders.

According to various embodiments, the user defined relationship symbology may be selectable from at least two types. A type of the user defined relationship symbology may include a line. Further, the user defined relationship symbology may include an arrow head. The first main folder may include at least one subfolder with an electronic file being represented as storable in the at least one subfolder, and the second main folder may include at least one subfolder with an electronic file being represented as storable in the at least one subfolder.

According to another aspect of the present invention, there is provided a computer system including a processing unit for use with an electronic display. The processing unit is configured to electronically communicate with the display for displaying an electronic file system graphic user interface for representation of electronic files. The electronic file system graphic user interface is as described above.

### BRIEF DESCRIPTION OF THE DRAWINGS

FIG. 1 is a front view of a computer system with monitor in accordance with an aspect of the present invention;

FIG. 2 is an enlarged front view of the monitor of FIG. 1 displaying an illustrative graphic user interface and display window;

FIG. 3 is an enlarged view of the graphic user interface of FIG. 2 with a pop-up window of a main folder;

FIG. 4 is the enlarged view of the graphic user interface of FIG. 3 with a selection pop-up window;

FIG. 5 is the enlarged view of the graphic user interface of FIG. 4 with an additional main folder and a prompted pop-up window;

FIG. 6 is the enlarged view of the graphic user interface of FIG. 5 with the pop-up selection window and a relationship symbology pop-up window; and

FIG. 7 is the enlarged view of the graphic user interface of FIG. 6 with selected relationship symbology associated with the additional main folder.

### DESCRIPTION OF THE PREFERRED EMBODIMENTS

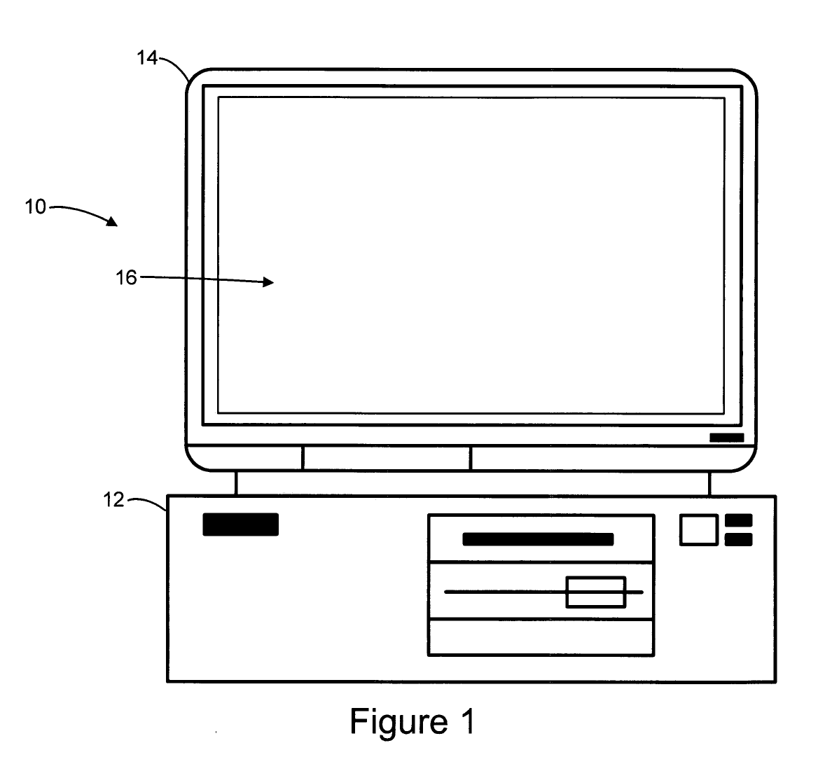

Referring now to the drawings wherein the showings are for purposes of illustrating preferred embodiments of the present invention only, and not for purposes of limiting the same, FIGS. 1-7 illustrate a research software tool in accordance with the aspects of the present invention.

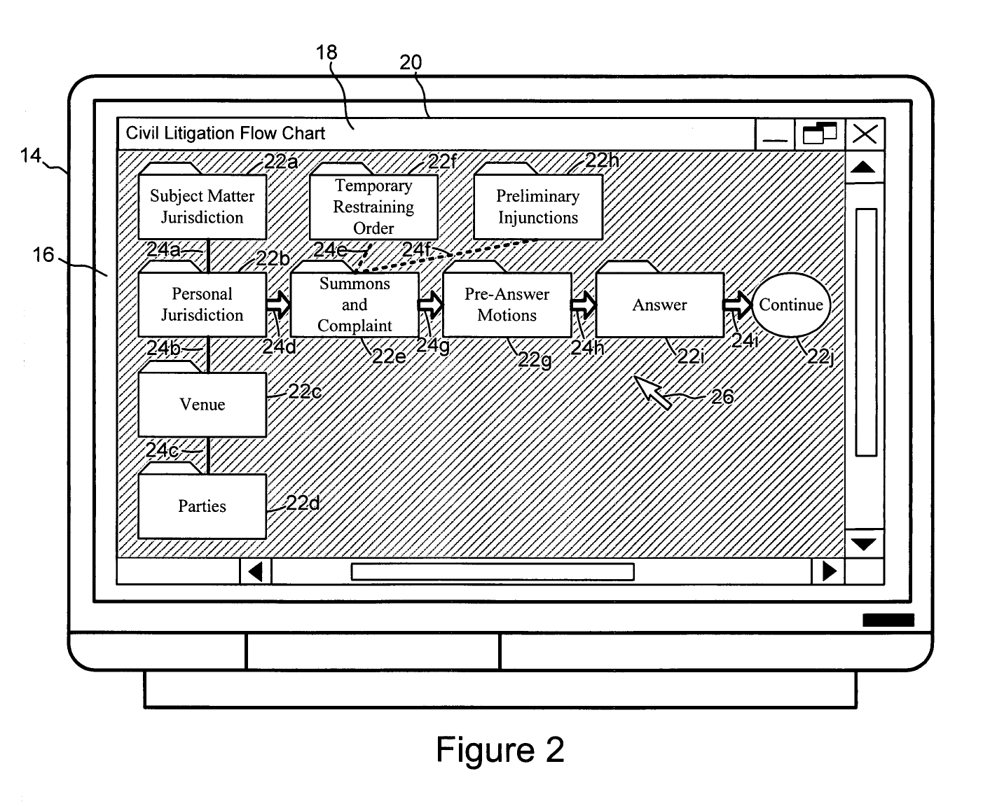

Referring now to FIG. 1, there is depicted a symbolic plan view of a computer system 10 in accordance with an aspect of the present invention. The computer system 10 includes a processing unit 12 and a monitor 14 with a screen 16. In this regard, FIG. 2 depicts an enlarged front view of the monitor 14 and screen 16. In the embodiment shown, displayed upon the screen 16 there is depicted an electronic file system graphic user interface 18 as it appears in a display window 20. In this example, the graphic user interface 18 is related to the topic of civil litigation and is labeled “Civil Litigation Flow Chart.” As shown, the graphic user interface 18 features a plurality of graphically indicated main folders 22a-j (each labeled with a sample topic related to civil litigation) and user defined relationship symbology 24a-i disposed between various ones of the main folders 22a-j as discussed in detail below. Preferably a user is allowed to interact with the graphic user interface 18 through controlled usage of a cursor 26. The cursor 26 may be moved to, various portions of the display window 20.

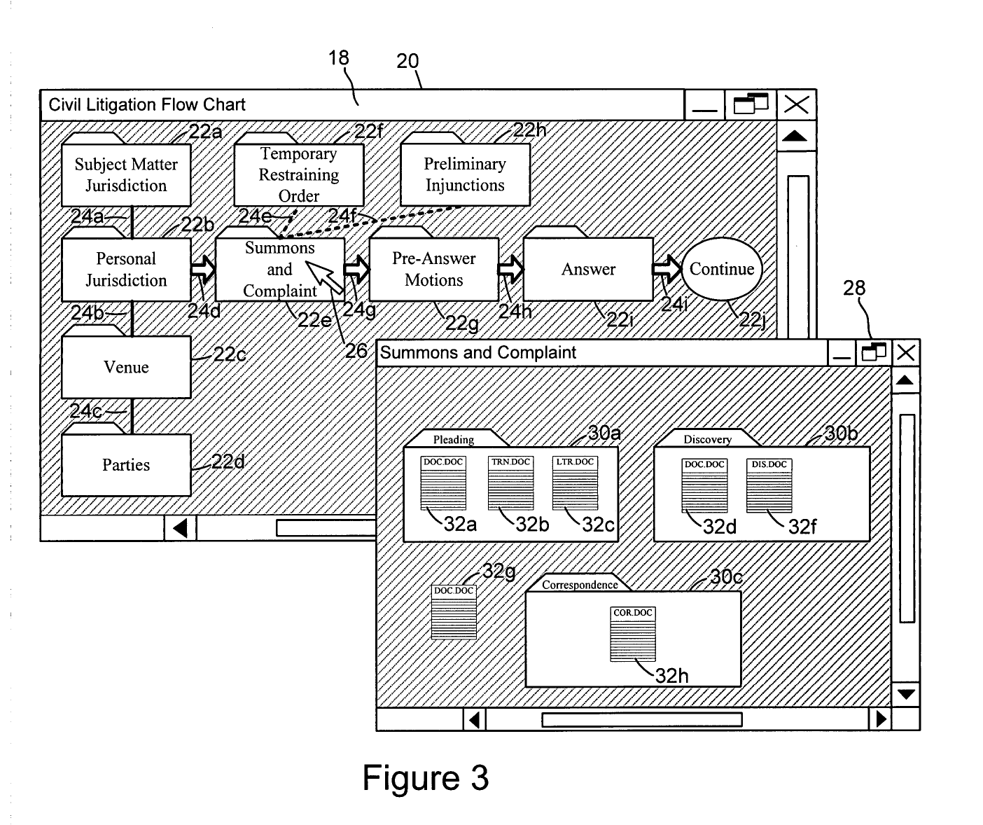

An aspect of the present invention can be regarded as the electronic file system graphic user interface 18 for representation of electronic files (such as electronic files 32a-h as seen in FIG. 3 discussed below). The graphic user interface 18 includes a graphically indicated first main folder (such as 22b), a graphically indicated second main folder (such as 22e), and user defined relationship symbology (24d) displayable between the first and second main folders 22b,e. The electronic files 32a-h are represented as storable in the first and second main folders 22b,e.

Referring now to FIG. 3 there is depicted the enlarged view of the graphic user interface 18 of FIG. 2 with a main folder window 28 of the main folder 22e labeled “Summons and Complaint.” In this regard, the main folder 22e may be “clickable” so as to initiate the opening of the main folder window 28 with the use of the cursor 26 positioned over the main folder 22 as shown. The main folder window 28 includes subfolders 30a-c. The electronic files 32a-c are shown as being disposed within the subfolder 30a, the electronic files 32d,f are shown as being disposed within the subfolder 30b, and the electronic file 32h is shown as being disposed within the subfolder 30c. The electronic file 32g is shown as being disposed simply within the main folder window 28.

Advantageously, the graphic user interface 18 enables a user to understand the electronic filing system in a visually intuitive manner. This is because the graphic user interface 18 utilizes the relationship symbology 24 between main folders 22 which allows the electronic files 32 to be stored and accessed in a flowchart format. The relative positioning of the various ones of the main folders 22 upon the display window 20 aid in the understanding of an end user of the various relationships between the main folders 22. In addition, the relationship symbology 24 further conveys information to the end user regarding the relationship between the main folders 22. The relative locations, types, and orientations of the main folders 22 and the relationship symbology 24 may all be utilized to convey information to the end user.

The electronic files 32 may be any storable file that may be electronically saved and retrieved. The various formats for such electronic files 32 may vary. For example, the electronic files 32 may be word processing documents, spread sheet files, scanned documents, image documents, e-mails, etc.

It is contemplated that the electronic files 32 can be co-indexed, synchronized or otherwise associated with other well known electronic document management programs (e.g., DOCSOPEN, IMANAGE), so users do not have to abandon and/or can concurrently use other document management programs. The electronic files 32 need not be stored at the same location as the software responsible for generating the graphic user interface 18. The electronic files 32 may be stored and accessed from one or many places including but not limited to the user's own computer, central server or online storage (which could be made available through an online application service provider (“ASP”) version of the software product responsible for generating the graphic user interface 18.

As used herein the term “main folder” refers to an electronic folder capable of containing an electronic file or subfolder. A main folder may itself be a subfolder. However, it is important to note that a given main folder cannot be linked through user defined relationship symbology to another main folder that is contained within such given main folder. Thus, by definition, a given main folder could not be linked to its own subfolder using the user defined relationship symbology.

The topical scope of the graphic user interface 18 may be unlimited. The example shown is related to civil procedure. Other sample topics or processes that lend themselves to presentation in a flowchart format for storing related electronic files may include, but are not limited to, specific issues in civil litigation such as discovery; evidence; criminal procedure; wage and labor law; constitutional law; appellate law; class actions; specific types of litigation (such a sexual and/or racial harassment lawsuits); contracting; corporate formation; mergers and acquisitions; securing protection of intellectual property; initial public offerings; private offerings; real estate purchase and sale agreements; buying and/or selling a home; basic home repair; traveling in a particular city or country; personal income taxes; trading stocks and other securities; developing photographs; buying and/or selling a franchise; schematics of the world's religions; asset allocation strategies; schematic of a space shuttle launch; diagnoses of a disease based on symptoms; fixing a television; adding memory to a personal computer or laptop; tune-up procedures for a vehicle; and specific vehicle repairs.

As mentioned above, in this example the graphic user interface 18 is related to the topic of civil litigation, and could be helpful to an end user or group of end users who are involved with a particular litigation, such as those in a law firm for example. The graphic user interface 18 facilitates the filing of the electronic files 32 in the context of the process of civil litigation. In this regard, by quickly scanning the graphic user interface 18 the end user is contemplated to understand that the electronic files related to “subject matter,” “personal jurisdiction”, “venue,” and “parties” (as indicated in the main folders 22a-d) are sequentially addressed prior to completion of the issue of “summons and complaint” (as indicated by the main folder 22e). Furthermore, the portion of the litigation process associated with the “summons and complaint” must be completed prior to moving on to the topic of “pre-answer motions” (as indicated in the main folder 22g). As such, a user that may not be familiar with the particular computer system of a given organization could interact with the graphic user interface 18 and intuitively access desired electronic files 32. This is because such electronic files 32 are stored in a manner which is more universally understood, i.e., the associated process. For example, a newly assigned attorney who begins work in an on-going lawsuit handled by a law firm could intuitively find, store, and access electronic files 32 by simply seeing the litigation process in the graphic user interface 18. In this regard, all electronic files 32 related to the issues of the “Answer” would be expected to be found somewhere within the main folder 22i which is so labeled.

As such, the graphic user interface 20 is intended to provide the end user with a visual organization of data, including relationships between various items of data (such as chronological, sequential or organizational relationships). These may be temporal as well as event based. This is in contrast to a typical electronic filing system that presents electronic files as being stored in a series of folders and subfolders which are arranged merely in an alphabetical manner or by date for example. While “window” type of electronic folders are known and may be positioned and disposed relative to each other in a “flowchart” manner, the present graphic user interface 18 is distinctive with the implementation of the user defined relationship symbology 24 as discussed further below.

Although the computer system 10 is depicted as being a personal computer, other configurations may be utilized. For example, the processing unit 12 may take the form of a processing unit of a laptop or a network server. In addition, it is contemplated that the functionality of the graphic user interface 18 may be programmed by any of those software techniques which are well known to one of ordinary skill in the art.

In further detail, the main folders 22 may take a variety of forms. In the example shown, the main folders 22 are indicated by a symbolic graphic of a physical folder. Other shapes may be utilized. Although the perimeter lining is shown as being black solid lined, any other lining may be utilized such as dotted or dashed, as well as various line thicknesses and colors (including clear).

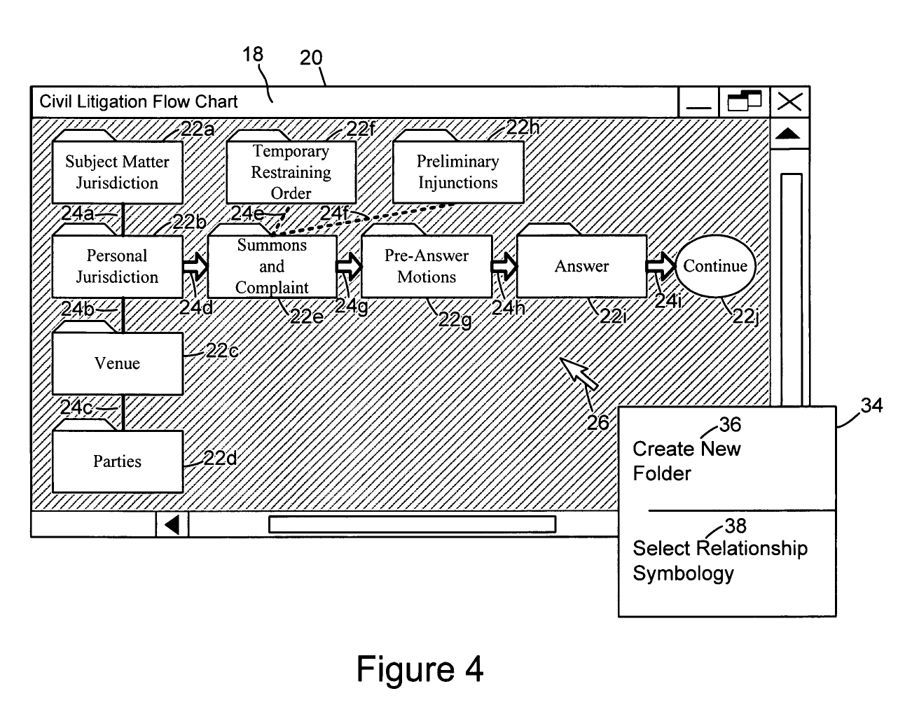

Referring now to FIGS. 4-7 there is depicted a sample sequence in the use of the graphic user interface 18 to create a new main folder. FIG. 4 depicts the enlarged view of the graphic user interface 18 of FIG. 3 with the cursor 26 repositioned to an open space of the display window 20.

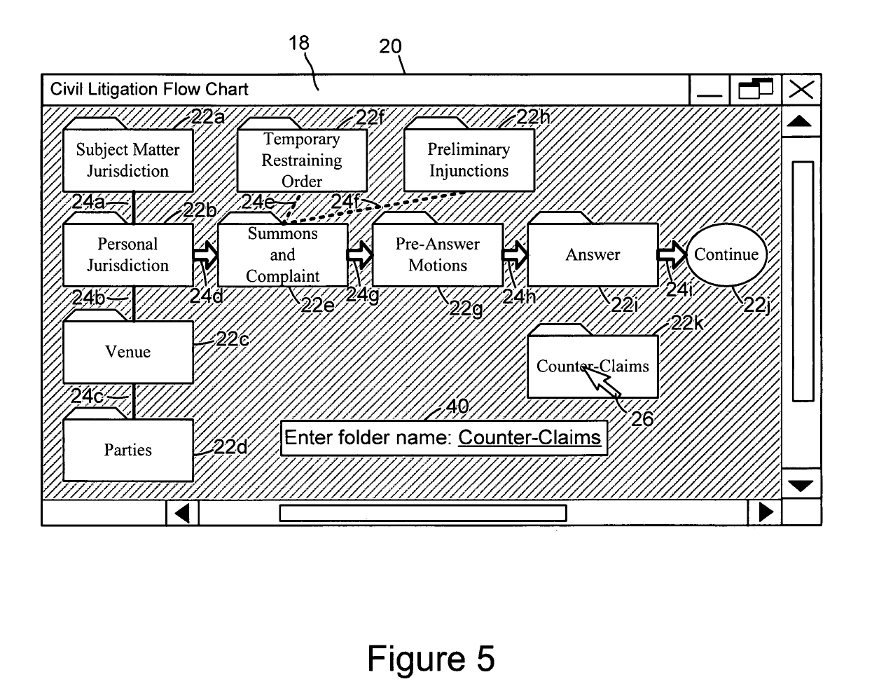

The graphic user interface 18 may be programmed to allow for pull-down menus or pop-up windows to be used for selection of various desired tasks. For example, “right clicking” of a user's computer mouse may result in a selection pop-up window 34 such as shown. In this example, the user may move the cursor 26 to the Create New Folder selection 36 of the selection pop-up window 34 and select it by “left clicking” the computer mouse. As shown in FIG. 5 after making such selection, a new main folder 22k is created at such location of the display window 20. The user may be prompted to associate a name or label with the main folder 22k as facilitated by a prompted pop-up window 40. In this case, the user is shown to have entered “Counter-Claims” as the name of the main folder 22k. Though not shown, it is contemplated that the user may also select a “Show Relationships” selection from the pop-up window 40. All symbology from the main folder would be demarked in a manner which would make them standout from others, and thus explicitly stating the relationships between main folder and subfolders. Thus all relationships which originate from a particular folder may be highlighted. Such as highlighting could be restricted to show only forward or reverse directional relationships for example.

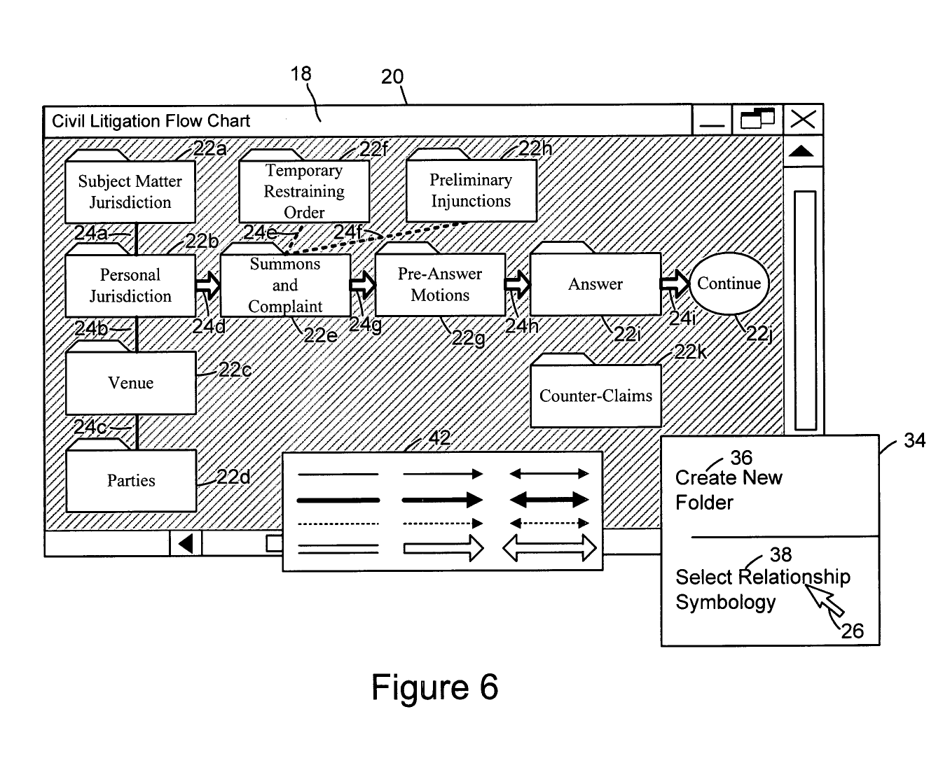

FIG. 6 is the enlarged view of the graphic user interface of FIG. 5. As can be seen, the cursor 26 is relatively moved down and to the right, and the computer mouse is presumed to have been right clicked so as to initiate the section pop-up window 34. The section pop-up window 34 further includes a Select Relationship Symbology selection 38. Left clicking of the computer mouse with the cursor 26 over the Section Relationship Symbology section 38 initiates the relationship symbology pop-up window 42. As shown for example, the relationship symbology pop-up window 42 contains various relationship symbology types that may be selected (including solid lines, thick solid lines, dashed lines and double lines, and all of which may include no arrow heads, or single arrow heads and double arrow heads).

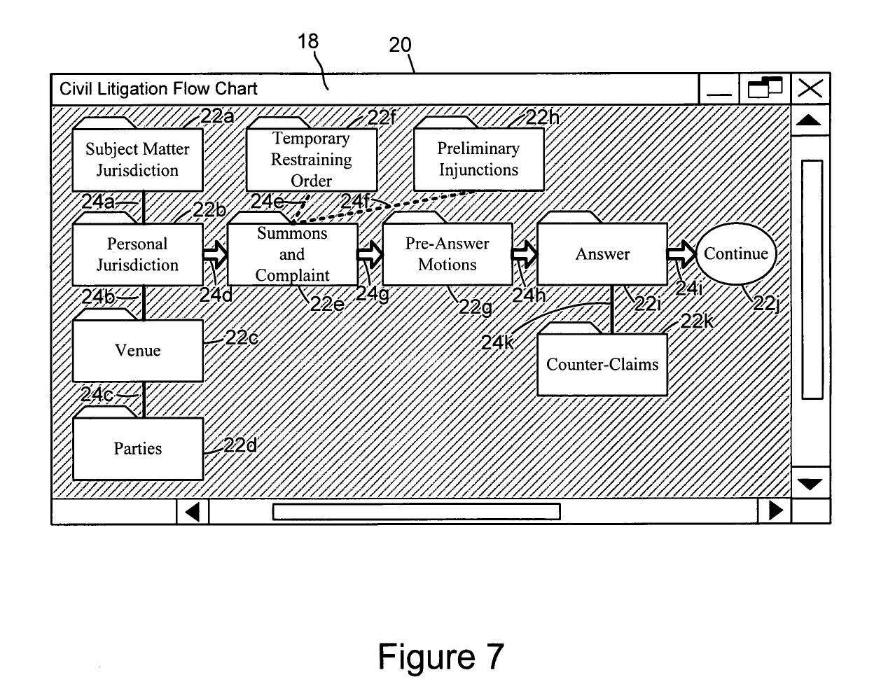

In this example, the user is contemplated to have chosen the simple solid line with no arrow heads. Further, the user is contemplated to have clicked both the main window 22i and the main window 22k. As seen in FIG. 7, this results in the creation of the user defined relationship symbology 24k disposed between the main folders 22i,k. As such, the user is contemplated to exercise control over the type of relationship symbology 24 displayed. In this regard, as used herein the term “user defined” refers to the ability of the user to interface with the graphic user interface 18 so as to exercise some degree of control in the selection of the relationship symbology 24 between main folders 22. Though not shown, the relationship symbology 24 may also be indicated in a variety of ways, including variances of shape, lining, background and/or color.

Another aspect of the invention is a software program that enables the user to create the graphic user interface 18, and/or modify an existing graphic user interface to thereby create the graphic user interface 18. Thus, a user may be able to customize the graphic user interface 18 to his/her own particular requirements or preferences. In this regard, this process may be conceptualized as an end user creating a database, such as in MS ACCESS, USING A MS VISIO-type visual interface. Such software could be configured with the end user with a few pre-existing graphic user interfaces 18 (such as specifically tailored to different topic such as personal finance, tracking/planning of a child's future for examples) into which an end user can file electronic files.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

We claim:

1. An electronic file system graphic user interface for representation of electronic files, the graphic user interface comprising:
a graphically indicated first main folder;
a graphically indicated second main folder; and
user defined relationship symbology displayable between the first and second main folders;
wherein the electronic files being represented as storable in the first and second main folders.

2. The electronic file system of graphic user interface of claim 1 wherein the user defined relationship symbology is selectable from at least two types.

3. The electronic file system graphic user interface of claim 1 wherein a type of the user defined relationship symbology includes a line.

4. The electronic file system graphic user interface of claim 1 wherein a type of the user defined relationship symbology includes an arrow head.

5. The electronic file system graphic user interface of claim 1 wherein the first main folder includes at least one subfolder with an electronic file being represented as storable in the at least one subfolder, the second main folder includes at least one subfolder with an electronic file being represented as storable in the at least one subfolder.

6. An electronic file system graphic user interface for representation of electronic files, the graphic user interface comprising:
a plurality of graphic user main folders; and
user defined relationship symbology displayable between at least one of the plurality of graphic user main folders and at least one other of the plurality of graphic user main folders;
wherein the electronic files being represented as storable in the graphic user main folders.

7. The electronic file system of graphic user interface of claim 6 wherein the user defined relationship symbology is selectable from at least two types.

8. The electronic file system graphic user interface of claim 6 wherein a type of the user defined relationship symbology includes a line.

9. The electronic file system graphic user interface of claim 6 wherein a type of the user defined relationship symbology includes an arrow head.

10. The electronic file system graphic user interface of claim 6 wherein at least one of the main folders includes at least one subfolder with an electronic file being represented as storable in the at least one subfolder, the second main folder includes at least one subfolder with an electronic file being represented as storable in the at least one subfolder.

11. A computer system comprising a processing unit for use with an electronic display, the processing unit configured to electronically communicate with the display for displaying an electronic file system graphic user interface for representation of electronic files, the graphic user interface including a graphically indicated first main folder, a graphically indicated second main folder, and user defined relationship symbology displayable between the first and second main folders, the electronic files being represented as storable in the first and second main folders.

12. The computer system of claim 11 wherein the user defined relationship symbology is selectable from at least two types.

13. The computer system of claim 11 wherein a type of the user defined relationship symbology includes a line.

14. The computer system of claim 11 wherein a type of the user defined relationship symbology includes an arrow head.

15. The computer system of claim 11 wherein at least one of the main folders includes at least one subfolder with an electronic file being represented as storable in the at least one subfolder, the second main folder includes at least one subfolder with an electronic file being represented as storable in the at least one subfolder.
